(19) United States
(12) Patent Application Publication
(10) Pub. No.: US 2022/0023005 A1
(43) Pub. Date: Jan. 27, 2022

(54) Orthodontic Appliance Covering Device

(71) Applicants: Kanayo Chigbue, Dublin, CA (US); Hamza Almririg, Dublin, CA (US)

(72) Inventors: Kanayo Chigbue, Dublin, CA (US); Hamza Almririg, Dublin, CA (US)

(21) Appl. No.: 16/935,801

(22) Filed: Jul. 22, 2020

(51) Int. Cl. A61C 7/08; A61C 7/12; A61C 13/08

(52) U.S. Cl. CPC A61C 7/08; A61C 13/082; A61C 7/12

(57) ABSTRACT

An orthodontic appliance covering device for shielding an orthodontic appliance from view and for mimicking a set of teeth includes a shell, which has a plurality of cavities positioned therein. Each cavity is complementary to at least one of a tooth and a portion of an orthodontic appliance. The shell has a first face, which is open for insertion of a set of teeth having the orthodontic appliance engaged thereto. Each cavity has an associated at least one of a tooth and a portion of an orthodontic appliance positioned therein. A plurality of protrusions is engaged to and extends from a front face of the shell. The plurality of protrusions is shaped complementarily to the set of teeth. The protrusions are substantially opaque and white and thus mimic the set of teeth and shield both the set of teeth the orthodontic appliance from view.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to covering devices and more particularly pertains to a new covering device for shielding an orthodontic appliance from view and for mimicking a set of teeth.

### (2) Description of Related Art Including Information Disclosed Under 37 CFR 1.97 and 1.98

The prior art relates to covering devices for orthodontic appliances. The prior art does not teach the base features of the invention.

### BRIEF SUMMARY OF THE INVENTION

An embodiment of the disclosure meets the needs presented above by generally comprising a shell, which has a plurality of cavities positioned therein. Each cavity is complementary to at least one of a tooth and a portion of an orthodontic appliance. The shell has a first face, which open and configured for insertion of a set of teeth having the orthodontic appliance engaged thereto. Each cavity has an associated at least one of a tooth and a portion of an orthodontic appliance positioned therein.

A plurality of protrusions is engaged to and extends from a front face of the shell. The plurality of protrusions is shaped complementarily to the set of teeth. The protrusions are substantially opaque and white and thus are configured to mimic the set of teeth and to shield both the set of teeth the orthodontic appliance from view.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an orthodontic appliance covering device according to an embodiment of the disclosure.

FIG. 2 is a bottom view of an embodiment of the disclosure.

FIG. 3 is a side view of an embodiment of the disclosure.

FIG. 4 is a back view of an embodiment of the disclosure.

FIG. 5 is an in-use view of an embodiment of the disclosure.

FIG. 6 is an isometric perspective view of an alternative embodiment of the disclosure.

FIG. 7 is a bottom view of an alternative embodiment of the disclosure.

FIG. 8 is a back view of an alternative embodiment of the disclosure.

FIG. 9 is an in-use view of an alternative embodiment of the disclosure.

### DETAILED DESCRIPTION OF THE INVENTION

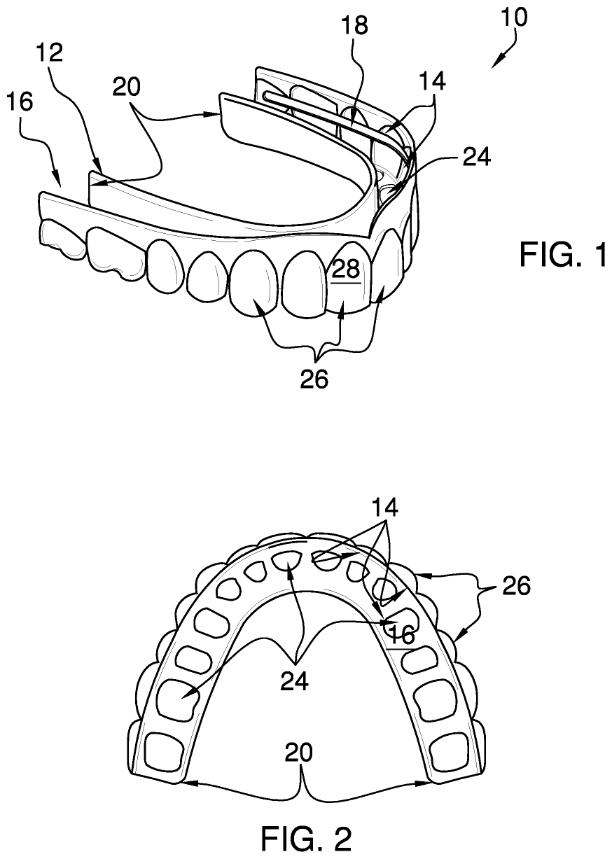

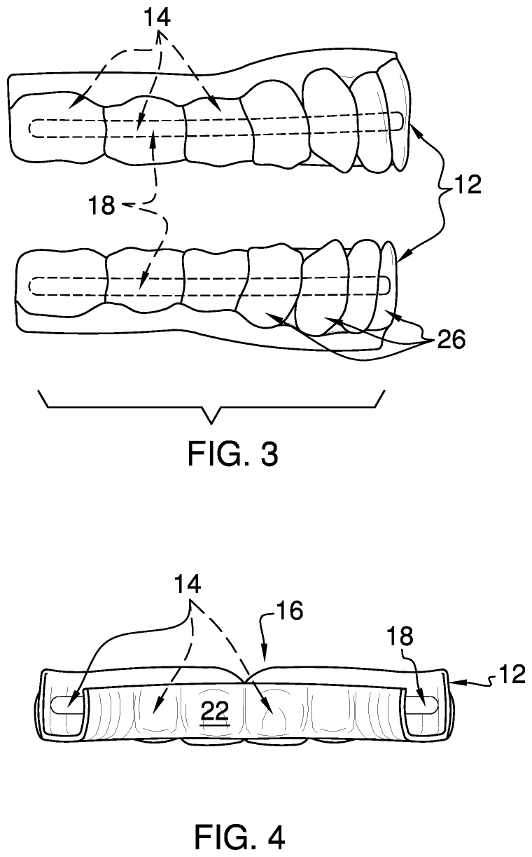

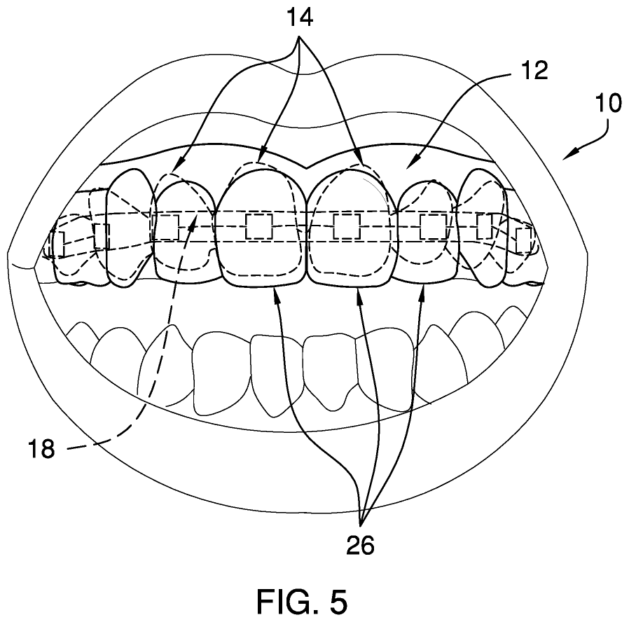

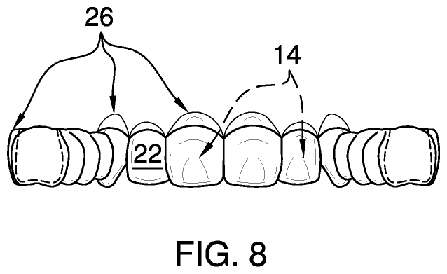

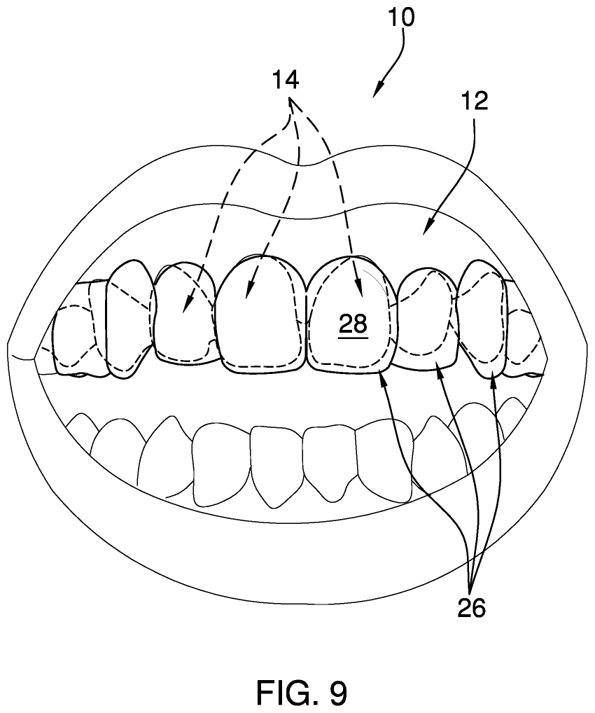

With reference now to the drawings, and in particular to FIGS. 1 through 9 thereof, a new covering device embodying the principles and concepts of an embodiment of the disclosure and generally designated by the reference numeral 10 will be described.

As best illustrated in FIGS. 1 through 9, the orthodontic appliance covering device 10 generally comprises a shell 12, which has a plurality of cavities 14 positioned therein. Each cavity 14 is complementary to at least one of a tooth and a portion of an orthodontic appliance, which should be interpreted to mean only a tooth, only a portion of an orthodontic appliance, or both a tooth and a portion of an orthodontic appliance.

The shell 12 has a first face 16, which is open and thus configured for insertion of a set of teeth having the orthodontic appliance engaged thereto. Each cavity 14 has an associated at least one of a tooth and a portion of an orthodontic appliance positioned therein. The plurality of cavities 14 may comprise a slot 18, which extends from proximate to opposed ends 20 of the shell 12. The slot 18 is configured for insertion of a wire of a set of braces that is engaged to the set of teeth.

The shell 12 is substantially transparent and comprises at least one of plastic and rubber, which should be interpreted to mean only plastic, only rubber, or a combination thereof.

The shell 12 may be one of a pair of shells 12. The first face 16 of one of the shells 12 is configured for insertion of a set of upper teeth and the first face 16 of the other of the shells 12 is configured for insertion of a set of lower teeth.

A second face 22 of the shell 12 may have a plurality of apertures 24 positioned therein, as shown in FIG. 2. Each aperture 24 is configured for partial insertion of an associated tooth. The apertures 24 allow contact of the set of upper teeth with a set of lower teeth.

A plurality of protrusions 26 is engaged to and extends from a front face 28 of the shell 12. The plurality of protrusions 26 is shaped complementarily to the set of teeth. The protrusions 26 are substantially opaque and white and thus are configured to mimic the set of teeth and to shield both the set of teeth the orthodontic appliance from view. Each protrusion 26 may have an associated cavity 14 extending thereinto.

The protrusions 26 of the plurality of protrusions 26 is positioned on the shell 12 so as to represent a positioning of the set of teeth upon completion of a realignment effected by the orthodontic appliance.

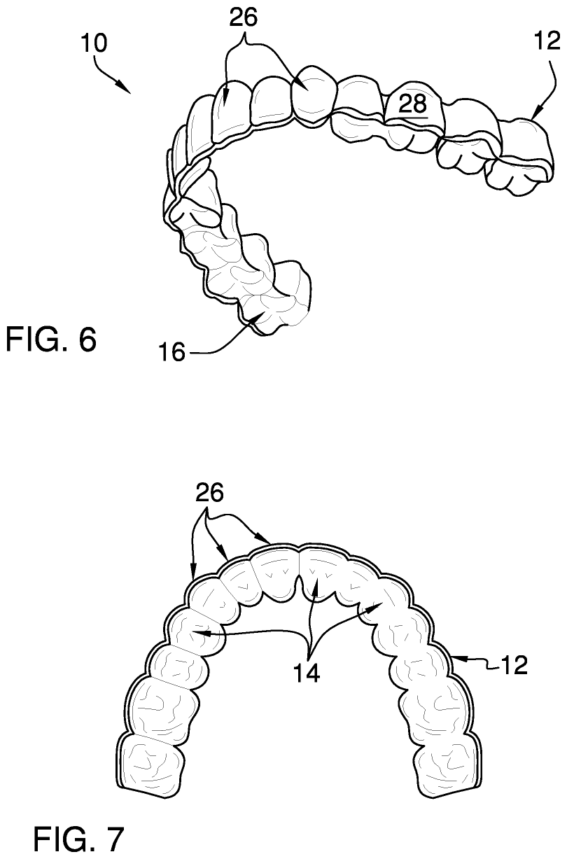

In one embodiment, as shown in FIGS. 6-9, the shell 12 comprises the orthodontic appliance and thus is configured to realign teeth of the set of teeth. The shell 12 of this embodiment comprises plastic.

In use, the shell 12 is positioned over a set of teeth and an orthodontic appliance. The protrusions 26 on the front face 28 of the shell 12 shield the set of teeth and the orthodontic appliance from view, while also mimicking the set of teeth in their ultimate, aligned, position post treatment.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. An orthodontic appliance covering device comprising:
a shell having a plurality of cavities positioned therein, each cavity being complementary to at least one of a tooth and a portion of an orthodontic appliance, the shell having a first face, the first face being open, wherein the first face is configured for insertion of a set of teeth having the orthodontic appliance engaged thereto, such that each cavity has an associated at least one of a tooth and a portion of an orthodontic appliance positioned therein; and
a plurality of protrusions engaged to and extending from a front face of the shell, the plurality of protrusions being shaped complementarily to the set of teeth, the protrusions being substantially opaque and white, wherein the plurality of protrusions is configured for mimicking the set of teeth and shielding both the set of teeth the orthodontic appliance from view.

2. The orthodontic appliance covering device of claim 1, wherein the shell is substantially transparent.

3. The orthodontic appliance covering device of claim 1, wherein the shell comprises at least one of plastic and rubber.

4. The orthodontic appliance covering device of claim 3, wherein:
the shell comprises plastic; and
the shell comprises the orthodontic appliance wherein the shell is configured for realigning teeth of the set of teeth.

5. The orthodontic appliance covering device of claim 1, wherein the plurality of cavities comprises a slot extending from proximate to opposed ends of the shell, wherein the slot is configured for inserting a wire of a set of braces engaged to the set of teeth.

6. The orthodontic appliance covering device of claim 1, wherein the protrusions of the plurality of protrusions are positioned on the shell such that the plurality of protrusions represents a positioning of the set of teeth upon completion of a realignment effected by the orthodontic appliance.

7. The orthodontic appliance covering device of claim 1, wherein each protrusion has an associated cavity extending thereinto.

8. The orthodontic appliance covering device of claim 1, further including a second face of the shell having a plurality of apertures positioned therein, wherein each aperture is configured for partial insertion of an associated tooth.

9. The orthodontic appliance covering device of claim 1, wherein the shell is one of a pair of shells, wherein the first face of one of the shells is configured for insertion of a set of upper teeth and the first face of the other of the shells is configured for insertion of a set of lower teeth.

10. The orthodontic appliance covering device of claim 4, wherein the shell is one of a pair of shells, wherein the first face of one of the shells is configured for insertion of a set of upper teeth and the first face of the other of the shells is configured for insertion of a set of lower teeth.

11. An orthodontic appliance covering device comprising:
a shell having a plurality of cavities positioned therein, each cavity being complementary to at least one of a tooth and a portion of an orthodontic appliance, the shell having a first face, the first face being open, wherein the first face is configured for insertion of a set of teeth having the orthodontic appliance engaged thereto, such that each cavity has an associated at least one of a tooth and a portion of an orthodontic appliance positioned therein, the shell being substantially transparent, the shell comprising at least one of plastic and rubber, the plurality of cavities comprising a slot extending from proximate to opposed ends of the shell, wherein the slot is configured for inserting a wire of a set of braces engaged to the set of teeth;
a plurality of protrusions engaged to and extending from a front face of the shell, the plurality of protrusions being shaped complementarily to the set of teeth, the protrusions being substantially opaque and white, wherein the plurality of protrusions is configured for mimicking the set of teeth and shielding both the set of teeth the orthodontic appliance from view, the protrusions of the plurality of protrusions being positioned on the shell such that the plurality of protrusions represents a positioning of the set of teeth upon completion of a realignment effected by the orthodontic appliance, each protrusion having an associated cavity extending thereinto; and
the shell being one of a pair of shells, wherein the first face of one of the shells is configured for insertion of a set of upper teeth and the first face of the other of the shells is configured for insertion of a set of lower teeth.

12. The orthodontic appliance covering device of claim 11, further including a second face of the shell having a plurality of apertures positioned therein, wherein each aperture is configured for partial insertion of an associated tooth.

13. The orthodontic appliance covering device of claim 11, wherein:
the shell comprises plastic; and
the shell comprises the orthodontic appliance wherein the shell is configured for realigning teeth of the set of teeth.
